(19) United States
(12) Patent Application Publication
(10) Pub. No.: US 2021/0280837 A1
(43) Pub. Date: Sep. 9, 2021

(54) BATTERY AND MANUFACTURING METHOD OF BATTERY

(71) Applicant: KABUSHIKI KAISHA TOSHIBA, Tokyo (JP)

(72) Inventors: Takashi ITO, Yokohama (JP); Takahiro AIZAWA, Yokohama (JP); Kazuo SHIMOKAWA, Yokohama (JP)

(73) Assignee: KABUSHIKI KAISHA TOSHIBA, Tokyo (JP)

(21) Appl. No.: 17/094,859

(22) Filed: Nov. 11, 2020

(30) Foreign Application Priority Data
Mar. 3, 2020 (JP) 2020-035785

(51) Int. Cl. H01M 2/26; H01M 10/0525

(52) U.S. Cl. CPC H01M 2/26; H01M 10/0525

(57) ABSTRACT

A battery includes an electrode group including positive electrode, a negative electrode, and a current collecting tab, a clip plate, and a connection lead. The clip plate includes a first engagement part, and is attached to the current collecting tab. The connection lead includes a second engagement part engageable with the first engagement part of the clip plate, and is connected to the current collecting tab via the clip plate. Movement of the connection lead relative to the clip plate is restricted by engagement of the second engagement part with the first engagement part.

### CROSS-REFERENCE TO RELATED APPLICATIONS

This application is based upon and claims the benefit of priority from Japanese Patent Application No. 2020-035785, filed Mar. 3, 2020; the entire contents of which are incorporated herein by reference.

### FIELD

Embodiments relate generally to a battery and a manufacturing method of the battery.

### BACKGROUND

In recent years, a high-capacity secondary battery capable of rapid charging and high-output discharging has been developed for a vehicle-mounted secondary battery and a power storage secondary battery. Such a secondary battery is required to have a higher capacity and a higher output.

As a battery such as a secondary battery, there is a battery in which an electrode group having a positive electrode and a negative electrode is housed in an inner cavity of an outer container. In this battery, the outer container includes a bottom wall and a peripheral wall, and a lid member is attached to the peripheral wall of the outer container at an end opposite to the bottom wall. The inner cavity of the outer container is closed by the lid member. In the battery, an electrode terminal is attached to an outer surface of the lid member, and a current collecting tab protrudes in the electrode group of the inner cavity. Then, the current collecting tab is electrically connected to the electrode terminal via a connection lead. Further, a clip plate is attached to the current collecting tab of the electrode group, and the connection lead is connected to the current collecting tab via the clip plate.

In the above-described battery, it is required to suppress displacement of the clip plate with respect to the current collecting tab and properly connect the connection lead to the current collecting tab in the work of connecting the connection lead to the current collecting tab.

### BRIEF DESCRIPTION OF THE DRAWINGS

FIG. 1 is a perspective view schematically showing an example of a battery according to an embodiment.

FIG. 2 is a perspective view schematically showing a portion where a clip plate according to the embodiment is attached to a current collecting tab.

FIG. 3 is a cross-sectional diagram schematically showing a cross section of the portion shown in FIG. 2 that is parallel or approximately parallel to a protruding direction of the current collecting tab.

FIG. 4 is a perspective view schematically showing an engagement portion of the clip plate and a connection lead, according to the embodiment.

FIG. 5 is a schematic diagram showing how the clip plate according to the embodiment is ultrasonically joined.

FIG. 6 is a cross-sectional diagram schematically showing a portion where a clip plate according to a modification is attached to a current collecting tab.

### DETAILED DESCRIPTION

According to an embodiment, a battery includes an electrode group including a positive electrode, a negative electrode, and a current collecting tab, a clip plate, and a connection lead. The clip plate includes a first engagement part, and is attached to the current collecting tab. The connection lead includes a second engagement part engageable with the first engagement part of the clip plate, and is connected to the current collecting tab via the clip plate. Movement of the connection lead relative to the clip plate is restricted by the engagement of the second engagement part with the first engagement part.

Further, according to the embodiment, in a manufacturing method of the battery, the electrode group including the positive electrode, the negative electrode, and the current collecting tab is formed. The clip plate on which the first engagement part is formed is attached to the current collecting tab. The clip plate, current collecting tab, and connection lead are joined in a state in which the second engagement part of the connection lead is engaged with the first engagement part.

Hereinafter, an embodiment will be described with reference to the drawings.

### Embodiment

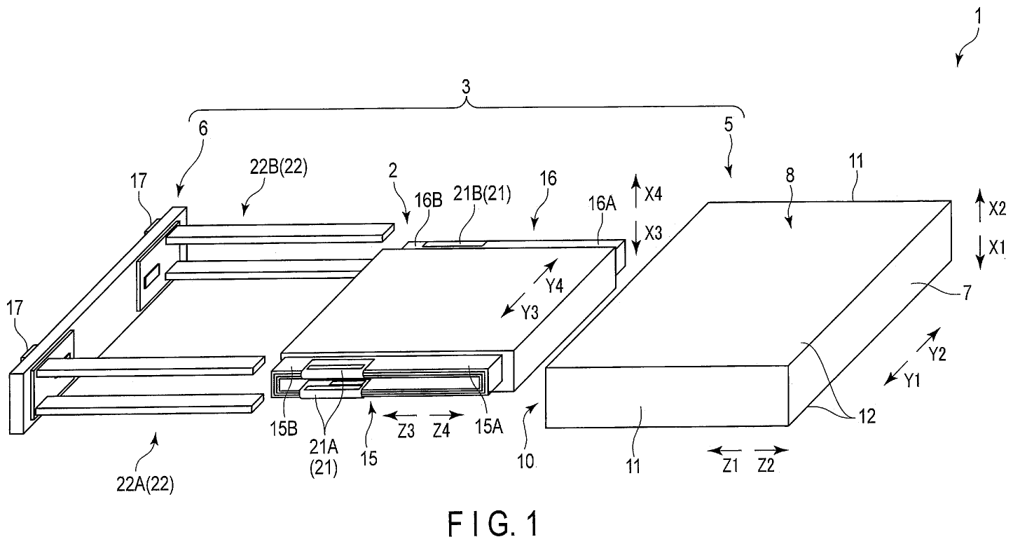

FIG. 1 shows an example of a battery 1. The battery 1 includes an electrode group 2 and an outer container 3 in which the electrode group 2 is housed. The outer container 3 is formed of a metal such as aluminum, an aluminum alloy, iron or stainless steel. The outer container 3 includes a container body 5 and a lid 6. Here, in the battery 1 and the outer container 3, a vertical direction (direction indicated by arrows X1 and X2), a horizontal direction (direction indicated by arrows Y1 and Y2) intersecting (perpendicular or approximately perpendicular to) the vertical direction, and a height direction (direction indicated by arrows Z1 and Z2) intersecting (perpendicular or approximately perpendicular to) both the vertical direction and the horizontal direction are defined. In each of the battery 1 and the outer container 3, the dimension in the vertical direction is much smaller than each of the dimension in the horizontal direction and the dimension in the height direction.

The container body 5 includes a bottom wall 7 and a peripheral wall 8. An inner cavity 10 in which the electrode group 2 is housed is defined by the bottom wall 7 and the peripheral wall 8. The inner cavity 10 opens toward a side opposite to the bottom wall 7 in the height direction. The peripheral wall 8 includes two pairs of side walls 11 and 12. The pair of side walls 11 face each other with the inner cavity 10 sandwiched therebetween in the horizontal direction. The pair of side walls 12 face each other with the internal cavity 10 sandwiched therebetween in the vertical direction. Each of the side walls 11 is continuously extended in the vertical direction between the side walls 12. Each of the side walls 12 is continuously extended in the horizontal direction between the side walls 11. The lid 6 is attached to the container body 5 at the opening of the inner cavity 10. Therefore, the lid 6 is attached to the peripheral wall 8 at an end opposite to the bottom wall 7. The lid 6 and the bottom wall 7 face each other with the inner cavity 10 sandwiched therebetween in the height direction.

The electrode group 2 is formed into, for example, a flat shape, and includes a positive electrode 15 and a negative electrode 16. In the electrode group 2, a separator (not shown) is interposed between the positive electrode 15 and the negative electrode 16. The separator is made of a material having electrical insulation properties, and electrically insulates the positive electrode 15 from the negative electrode 16.

The positive electrode 15 includes a positive electrode current collector 15A such as a positive electrode current collecting foil, and a positive electrode active material-containing layer (not shown) supported on a surface of the positive electrode current collector 15A. The positive electrode current collector 15A is, but is not limited to, for example, an aluminum foil or an aluminum alloy foil, and has a thickness of about 10 μm to 20 μm. The positive electrode active material-containing layer includes a positive electrode active material, and may optionally contain a binder and an electro-conductive agent. Examples of the positive electrode active material include, but are not limited to, oxides, sulfides, and polymers, which can occlude and release lithium ions. The positive electrode current collector 15A includes a positive electrode current collecting tab 15B as a portion not supporting the positive electrode active material-containing layer. The positive electrode current collecting tab 15B is provided at an end of the positive electrode 15 so as to protrude from a portion where the positive electrode active material-containing layer is supported on the surface of the positive electrode current collector 15A.

The negative electrode 16 includes a negative electrode current collector 16A such as a negative electrode current collecting foil, and a negative electrode active material-containing layer (not shown) supported on a surface of the negative electrode current collector 16A. The negative electrode current collector 16A is, but is not limited to, for example, an aluminum foil, an aluminum alloy foil, or a copper foil, and has a thickness of about 10 μm to 20 μm. The negative electrode active material-containing layer includes a negative electrode active material, and may optionally contain a binder and an electro-conductive agent. Examples of the negative electrode active material include, but are not limited to, metal oxides, metal sulfides, metal nitrides, and carbon materials, which can occlude and release lithium ions. The negative electrode current collector 16A includes a negative electrode current collecting tab 16B as a portion not supporting the negative electrode active material-containing layer. The negative electrode current collecting tab 16B is provided at the end of the negative electrode 16 so as to protrude from the portion where the negative electrode active material-containing layer is supported on the surface of the negative electrode current collector 16A.

In the electrode 2, a width direction (direction indicated by arrows Z3 and Z4) intersecting (perpendicular or approximately perpendicular to) a protruding direction (direction indicated by arrows Y3 and Y4) of the current collecting tabs 15B and 16B, and a thickness direction (direction indicated by arrows X3 and X4) intersecting (perpendicular or approximately perpendicular to) both the protruding direction of the current collecting tabs 15B and 16B and the width direction are defined. In the inner cavity 10, the electrode group 2 is arranged in a state in which the width direction coincides with or approximately coincides with the height direction of the battery 1, and the thickness direction coincides with or approximately coincides with the vertical direction of the battery 1.

In the inner cavity 10, the electrode group 2 holds (is impregnated with) an electrolytic solution (not shown). The electrolytic solution may be a nonaqueous electrolytic solution obtained by dissolving an electrolyte in an organic solvent, or an aqueous electrolytic solution such as an aqueous solution. Instead of the electrolytic solution, a gel electrolyte may be used, and a solid electrolyte may be used. If a solid electrolyte is used as an electrolyte, the solid electrolyte is interposed between the positive electrode 15 and the negative electrode 16 instead of the separator in the electrode group 2. In this case, the positive electrode 15 is electrically insulated from the negative electrode 16 by the solid electrolyte.

In the battery 1, a pair of electrode terminals 17 are attached to an outer surface (top surface) of the lid 6 of the outer container 3. The electrode terminals 17 are made of an electro-conductive material such as a metal. One of the electrode terminals 17 is a positive electrode terminal of the battery 1 while the other of the electrode terminals 17 is a negative electrode terminal of the battery 1. An insulating member (not shown) is provided between each of the electrode terminals 17 and the lid 6. Each of the electrode terminals 17 is electrically insulated from the outer container 3 including the lid 6 by the insulating member.

A clip plate 21 and a connection lead 22 are attached to the current collecting tabs 15B and 16B of the electrode group 2. The positive electrode current collecting tab 15B of the electrode group 2 is electrically connected to the positive electrode terminal, which is a corresponding one of the electrode terminals 17, via a positive electrode-side clip plate 21A and a positive electrode lead including a positive electrode-side connection lead 22A. The negative electrode current collecting tab 16B of the electrode group 2 is electrically connected to the negative electrode terminal, which is a corresponding one of the electrode terminals 17, via a negative electrode-side clip plate 21B and a negative electrode lead including a negative electrode-side connection lead 22B. Each of the positive electrode lead and the negative electrode lead is made of an electro-conductive material such as a metal. The positive electrode lead and the negative electrode lead do not move or rarely move relative to the electrode group 2.

In the inner cavity 10 of the outer container 3, each of the positive electrode current collecting tab 15B and the positive electrode lead is electrically insulated from the outer container 3 (the container body 5 and the lid 6) by one or more insulating members (not shown). Similarly, in the inner cavity 10 of the outer container 3, each of the negative electrode current collecting tab 16B and the negative electrode lead is electrically insulated from the outer container 3 by one or more insulating members (not shown). The configuration of the battery of the embodiment, etc. is not limited to the above-described configuration.

That is, the battery may be formed such that a clip plate to be described later is attached to a current collecting tab.

Hereinafter, the positive electrode-side clip plate 21A and the negative electrode-side clip plate 21B are described as the clip plate 21. In addition, the positive electrode-side connection lead 22A and the negative electrode-side connection lead 22B are described as the connection lead 22.

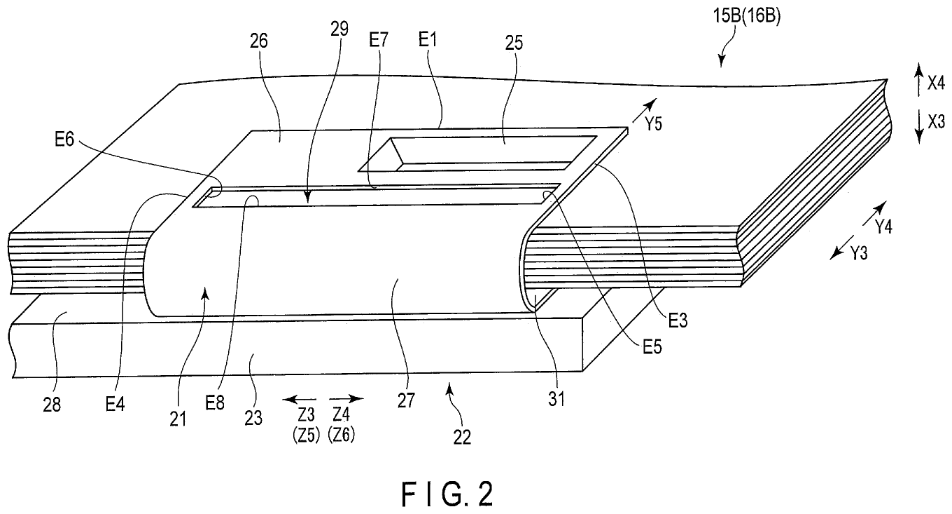

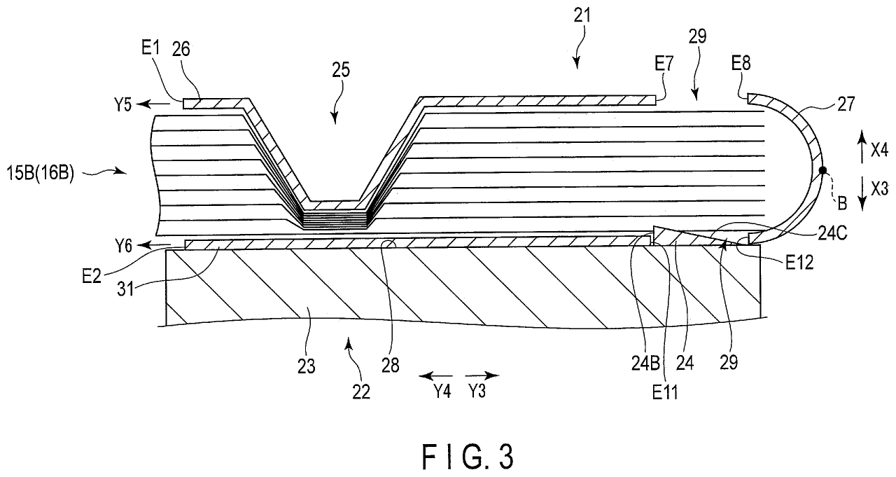

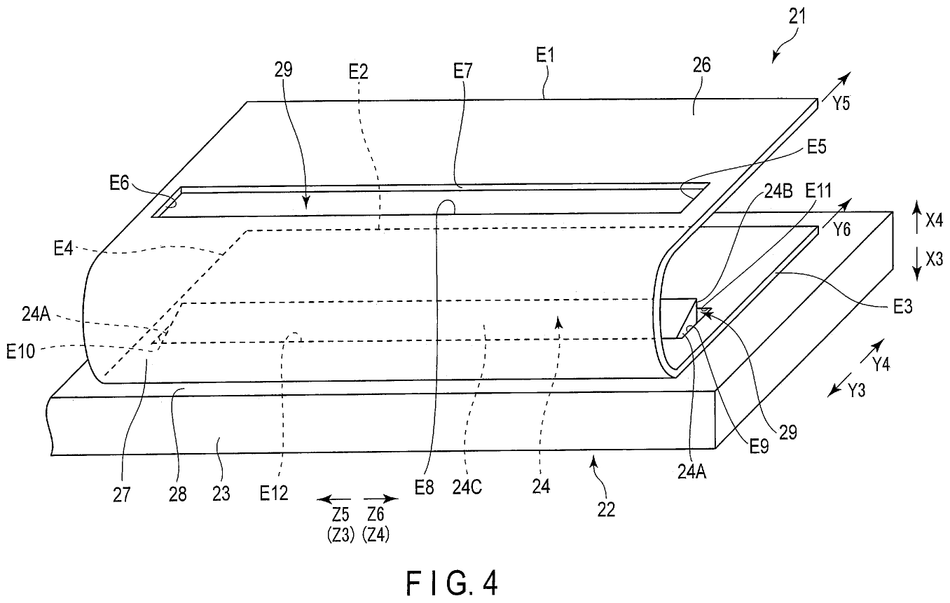

FIG. 2 is a perspective view schematically showing a portion where the clip plate 21 is attached to the current collecting tab (the corresponding one of 15B and 16B). FIG. 3 is a cross-sectional diagram schematically showing the portion shown in FIG. 2. FIG. 4 is a perspective view schematically showing a state in which the clip plate 21 and the connection lead 22 are engaged. Also in FIGS. 2 to 4, the protruding direction of the current collecting tabs 15B and 16B, width direction, and thickness direction are defined in the electrode group 2 in the same manner as in FIG. 1.

As shown in FIG. 2, the clip plate 21 electrically connects the current collecting tab (the corresponding one of 15B and 16B) and the connection lead 22. The clip plate 21 is attached to the current collecting tab (the corresponding one of 15B and 16B) from the protruding side of the current collecting tab. The clip plate 21 sandwiches the current collecting tab (the corresponding one of 15B and 16B) from both sides of the thickness direction of the electrode group 2. Part of the clip plate 21 is adjacent to both the connection lead 22 and the current collecting tab (the corresponding one of 15B and 16B) in a state of being sandwiched between the connection lead 22 and the current collecting tab (the corresponding one of 15B and 16B) in the thickness direction of the electrode group 2. With the above-described configuration, the connection lead 22 is connected to the current collecting tab (the corresponding one of 15B and 16B) via the clip plate 21.

The clip plate 21 includes edges E1 to E4, a pair of plate parts, and a folded part 27. The pair of plate parts are a plate part (first plate part) 26 and a plate part (second plate part) 31. The first engagement part is formed on the plate parts 26 and 31. The edge E2 is provided on the opposite side to the edge E1. The edge E4 is provided on the opposite side to the edge E3. The edges E3 and E4 each extend from the edge E1 to the edge E2. In one example, the edge E1 is provided in parallel or approximately parallel to the edge E2. The edge E3 is provided in parallel or approximately parallel to the edge E4.

In the clip plate 21, a plate width direction (direction indicated by arrows Z5 and Z6), a first direction (direction indicated by arrow Y5) in which the edges E3 and E4 extend through the second plate part 31, folded part 27, and first plate part 26 in this order, and a second direction (direction indicated by arrow Y6) in which the edges E3 and E4 extend through the first plate part 26, folded part 27, and second plate part 31 in this order, are defined. The first and second directions intersect the plate width direction in a state in which the first and second directions are perpendicular or approximately perpendicular to the plate width direction. In the clip plate 21, the first direction, the second direction, and a plate thickness direction intersecting (perpendicular or approximately perpendicular to) the plate width direction are defined. The clip plate 21 is arranged in a state in which the plate width direction coincides or approximately coincides with the width direction of the electrode group 2.

The plate part 26 is joined to the current collecting tab (the corresponding one of 15B and 16B) so as to electrically connect the current collecting tab (the corresponding one of 15B and 16B) and the clip plate 21. A plate width direction of each of the plate parts 26 and 31 coincides or approximately coincides with the plate width direction of the clip plate 21. A plate thickness direction of each of the plate parts 26 and 31 coincides or approximately coincides with the plate thickness direction of the clip plate 21. The plate part 31 is arranged apart from the plate part 26 to one side of the plate thickness direction of the plate part 26. The plate part 31 faces the plate part 26 from one side of the plate thickness direction of the plate part 26. The folded part 27 folds the plate part 26 toward the plate part 31. The folded part 27 extends between the plate parts 26 and 31. At the folded part 27, a folding line B of the plate part 31 with respect to the plate part 26 is formed. The folding line B extends from the edge E3 to the edge E4 in the plate width direction.

The first engagement part is formed to be engageable with the second engagement part formed on the connection lead 22 to be described later. The shape of the first engagement part is not limited as long as it is engageable with the second engagement part. The first engagement part is formed on at least one of the plate parts 26 and 31. In one example, the first engagement part is an opening part 29 formed in each of the plate parts 26 and 31.

One of the opening parts 29 is formed on the plate part 26, i.e., between the edge E1 and the folded part 27. One of the opening parts 29 is formed on an inner side of the edges E3 and E4 in the plate width direction. One of the opening parts 29 that is not formed on the plate part 26 is formed on the plate part 31, i.e., between the edge E2 and the folded part 27. One of the opening parts 29 that is not formed on the plate part 26 is formed on an inner side of the edges E3 and E4 in the plate width direction. That is, an opening edge of one of the opening parts 29 is formed on the plate part 26. An opening edge of one of the opening parts 29 that is not formed on the plate part 26 is formed on the plate part 31.

The opening edge of one of the opening parts 29 includes a pair of edges (a pair of first edges) separated from each other in the plate width direction of the plate part 26, and a pair of edges (a pair of second edges) separated from each other in the first direction (second direction). The pair of first edges are edges E5 and E6. The pair of second edges are edges E7 and E8. The edges E7 and E8 extend from the edge E5 to the edge E6.

The opening edge of one of the opening parts 29 that is not formed on the plate part 26 includes a pair of edges (a pair of third edges) separated from each other in the plate width direction of the plate part 31, and a pair of edges (a pair of fourth edges) separated from each other in the second direction (first direction). The pair of third edges are edges E9 and E10. The pair of fourth edges are edges E11 and E12. The edges E11 and E12 extend from the edge E9 to the edge E10.

The clip plate 21 is, for example, joined to the current collecting tab (the corresponding one of 15B and 16B) by ultrasonic welding. Thus, a joint 25 is formed on the clip plate 21. The joint 25 is formed at a portion connecting the clip plate 21 and the current collecting tab (the corresponding one of 15B and 16B). At the joint 25, the clip plate 21 is recessed toward the current collecting tab side in the thickness direction of the electrode group 2. The size of a range in which the joint 25 is formed in the clip plate 21 may be a size that can maintain the state in which the clip plate 21 is joined to the current collecting tab (the corresponding one of 15B and 16B). In one example, the depth of the recess at the joint 25 is shallow with respect to the thickness of the current collecting tab (the corresponding one of 15D and 16B) in the thickness direction of the electrode group 2. Therefore, the joint 25 does not penetrate the current collecting tab (the corresponding one of 15B and 16B) in the thickness direction of the electrode group 2.

In one example, the clip plate 21 is formed in plane symmetry or approximately plane symmetry with a center plane (not shown) in the plate width direction as a plane of symmetry. Each of the opening parts 29 is formed in plane symmetry or approximately plane symmetry with the center plane of the clip plate 21 in the plate width direction as a plane of symmetry. In addition, a virtual plane (not shown) that bisects an angle formed by the plate parts 26 and 31 at the folded part 27 is defined. The clip plate 21 is formed in plane symmetry or approximately plane symmetry with the virtual plane as a plane of symmetry, except that the joint 25 is formed at the plate part 26. The pair of opening parts 29 are formed in plane symmetry or approximately plane symmetry with each other with the virtual plane as a plane of symmetry.

The connection lead 22 includes a connector 23 and the second engagement part. The connector 23 electrically connects the connection lead 22 and the clip plate 21. The connector 23 extends in the width direction of the electrode group 2. The connector 23 is adjacent to the clip plate 21 on a main surface (adjacent surface) 28 from one side in the thickness direction of the electrode group 2. The connector 23 is formed in a plate shape or an approximately plate shape. A plate thickness direction of the connector 23 coincides or approximately coincides with the thickness direction of the electrode group 2. In one example, the thickness of the connector 23 in the plate thickness direction is thicker than the thickness of each of the plate parts 26 and 31 of the clip plate 21 in the plate thickness direction.

The second engagement part is formed to be engageable with the above-described first engagement part formed on the clip plate 21. The second engagement part is formed in the connector 23. The shape of the second engagement part is not limited as long as it is engageable with the first engagement part. In one example, when the first engagement part forms the opening part 29 on the clip plate 21, the second engagement part forms a protrusion 24 on the connection lead 22.

The protrusion 24 is formed to be insertable into the opening part 29 of the clip plate 21. The protrusion 24 protrudes from the main surface (adjacent surface) 28 of the connector 23 to one side of the thickness direction of the electrode group 2. The closer to a protrusion end of the current collecting tab (the corresponding one of 15B and 16B) from the electrode group 2 (closer to an end side of the positive electrode 15 or the negative electrode 16), the smaller a protrusion amount of the protrusion 24 from the main surface (adjacent surface) 28 to one side of the thickness direction of the electrode group 2. That is, a portion of a protrusion end of the protrusion 24 that is farther from a protrusion base of the current collecting tab (the corresponding one of 15B and 16B) that is protruding from a portion of the positive electrode current collector 15A or the negative electrode current collector 16A on which the positive electrode active material-containing layer or the negative electrode active material-containing layer is supported is closer to the main surface (adjacent surface) 28.

In one example, the protrusion 24 includes a pair of side surfaces 24A, a first surface 24B, and a second surface 24C, which is a protruding end surface. The pair of side surfaces 24A face the width direction of the electrode group 2, and are arranged apart from each other in the width direction of the electrode group 2. The first surface 24B and the second surface 24C extend in the width direction of the electrode group 2 between the pair of side surfaces 24A. The first surface 24B extends from the adjacent surface 28 to one side of the thickness direction of the electrode group 2. The first surface 24B is arranged on a side closer to the protrusion base of the current collecting tab (the corresponding one of 15B and 16B) than the second surface 24C. The second surface 24C is arranged on a side where the current collecting tab (the corresponding one of 15B and 16B) protrudes more than the first surface 24B. On the second surface 24C, the closer to the protrusion base of the current collecting tab (the corresponding one of 15B and 16B), the greater the distance from the adjacent surface 28. In other words, the closer the second surface 24C is to the protrusion end of the current collecting tab (the corresponding one of 15B and 16B), the smaller the distance from the adjacent surface 28.

As shown in FIG. 4, in the clip plate 21, the folded part 27 is arranged on a side where the current collecting tab (the corresponding one of 15B and 16B) protrudes in relation to the current collecting tab. In a state of such an arrangement, the second engagement part of the connection lead 22 is engaged with the first engagement part of the clip plate 21. In this engaged state, the first engagement part includes a plurality of abutting parts, and the second engagement part includes a plurality of receiving parts. The abutting parts abut on the connection lead at positions different from one another. A corresponding one of the abutting parts abuts on each of the receiving parts.

In one example, the opening part 29 is formed as the first engagement part on the clip plate 21, and the protrusion 24 is formed as the second engagement part on the connection lead 22. In this case, the protrusion 24 of the connection lead 22 is inserted into the opening part 29 from one side of the thickness direction of the electrode group 2. Thus, the protrusion 24 is arranged inside the opening part 29, and the adjacent surface 28 contacts the plate part 31 of the clip plate 21.

As described above, in one example, the protrusion 24 includes the pair of side surfaces 24A, first surface 24B, and second surface 24C. Each of the pair of side surfaces 24A abuts on a corresponding one of the pair of third edges E9 and E10 from the inside of the opening part 29 in the width direction of the electrode group 2. The first surface 24B abuts on the edge E11 of the opening part 29 from the side where the current collecting tab protrudes. Since the protrusion 24 and the opening part 29 are arranged in this manner, each of the edges E9, E10, and E11 of the opening part 29 becomes a corresponding one of the plurality of abutting parts of the first engagement part, and each of the pair of side surfaces 24A and the first surface 24B is a corresponding one of the plurality of receiving parts of the second engagement part.

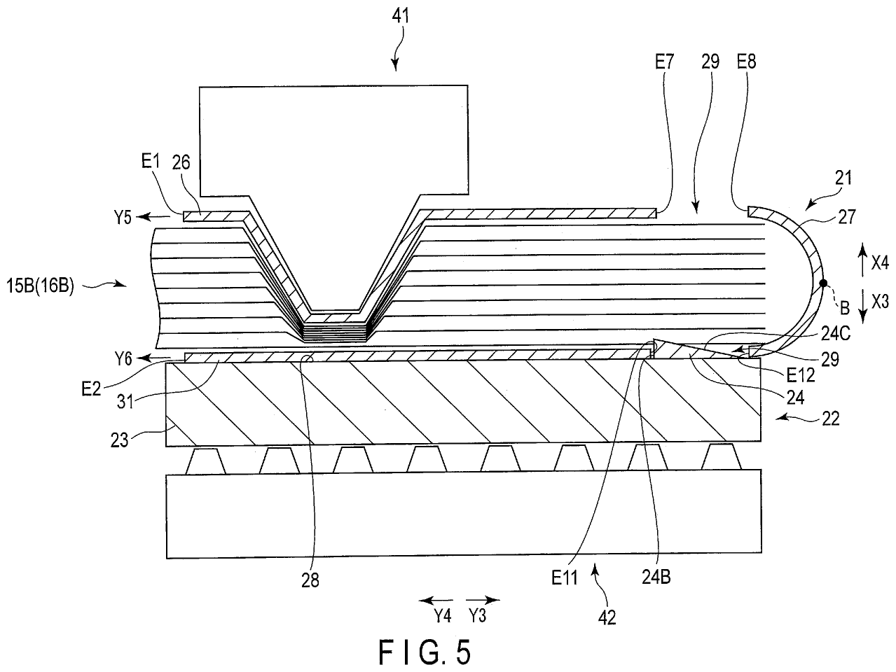

FIG. 5 is a schematic diagram showing how the clip plate 21 is ultrasonically joined. Also in FIG. 5, the protruding direction of the current collecting tabs 15B and 16B, width direction, and thickness direction are defined in the electrode group 2 in the same manner as in FIGS. 2 to 4.

When the clip plate 21 is joined to the current collecting tab (the corresponding one of 15B and 16B), the clip plate 21 is attached to the current collecting tab (the corresponding one of 15B and 16B) so as to sandwich the current collecting tab (the corresponding one of 15B and 16B) between the plate part 26 and the plate part 31 in the thickness direction of the electrode group 2. As described above, the clip plate 21 is arranged in a state in which the folded part 27 is located on a side where the current collecting tab (the corresponding one of 15B and 16B) protrudes with respect to the current collecting tab (the not-corresponding one of 15B and 16B) and the edges E1 and E2 face the electrode group 2 side. In a state in which the adjacent surface 28 faces the clip plate 21 from one side in the thickness direction of the electrode group 2, the second engagement part of the connection lead 22 is engaged with the first engagement part of the clip plate 21. That is, the connection lead 22 is arranged in a state in which the adjacent surface 28 faces the current collecting tab (the corresponding one of 15B and 16B) side in the thickness direction of the electrode group 2.

Next, an ultrasonic horn 41 is abutted on the plate part 26, and an anvil 42 is abutted on the connector 23 from an opposite side of the ultrasonic horn 41 in the thickness direction of the electrode group 2. The ultrasonic horn 41 abuts on the plate part 26. The plate part 26 is joined to the current collecting tab (the corresponding one of 15B and 16B) by ultrasonic vibrations transmitted by the ultrasonic horn 41. Thus, a joint 25 of the plate part 26 and the current collecting tab (the corresponding one of 15B and 16B) is formed on the plate part 26. The joint 25 is formed by the plate part 26 deforming toward the plate part 31 side in the thickness direction of the electrode group 2. A portion of the current collecting tab sandwiched between the plate parts 26 and 31 deforms in accordance with the deformation of the plate part 26. With the above-described arrangement, the clip plate 21 is joined to the current collecting tab (the corresponding one of 15B and 16B), and is also positioned with respect to the connection lead 22.

In the battery 1 of the present embodiment, the clip plate 21 includes the first engagement part, and the connection lead 22 includes the second engagement part. When connecting the connection lead 22 to the current collecting tab, the clip plate 21 is attached to the current collecting tab (the corresponding one of 15B and 16B), and the connection lead 22 is connected to the current collecting tab (the corresponding one of 15B and 16B) via the clip plate 21, as described above. At this time, the second engagement part is engaged with the first engagement part. Thus, movement of the clip plate 21 including the first engagement part relative to the connection lead 22 including the second engagement part is restricted. Displacement of the clip plate 21 with respect to the connection lead 22 can thus be suppressed. As a result, the connection lead 22 is appropriately connected to the current collecting tab (the corresponding one of 15B and 16B).

In the battery 1 of the present embodiment, it is preferable that the first engagement part be the opening part 29 formed on the clip plate 21, and the second engagement part be the protrusion 24 protruding from the connection lead 22. In this case, the protrusion 24 is inserted into the opening part 29 of the clip plate 21 so that the second engagement part is engaged with the first engagement part. As described above, by forming the first engagement part and the second engagement part, displacement of the clip plate 21 with respect to the connection lead 22 can be further suppressed. Thereby, the connection lead 22 is more appropriately connected to the current collecting tab (the corresponding one of 15B and 16B).

In the battery 1 of the present embodiment, the protrusion 24 as the second engagement part is preferably such that a protrusion amount from the connection lead decreases toward the end side of the current collecting tab (the corresponding one of 15B and 16B). In a case where the clip plate 21 is attached to the connection lead 22, the protrusion 24 is inserted into the opening part 29 as described above. If the protrusion 24 is formed as described above at this time, it is easy to insert the protrusion 24 into the opening part 29. Thus, the clip plate 21 can be easily aligned with the connection lead 22 and can be easily assembled.

In the battery 1 of the present embodiment, it is preferable that the first engagement part of the clip plate 21 include a plurality of abutting parts, and that the second engagement part of the connection lead 22 include a plurality of receiving parts. In a case where the first engagement part forms the opening part 29 and the second engagement part forms the protrusion 24, each of the edges E9, E10, and E11 of the opening part 29 becomes the abutting part, and each of the pair of side surfaces 24A and the first surface 24B becomes the receiving part. When the first engagement part is engaged with the second engagement part, each of the edges E9 and E10 abuts on a corresponding one of the pair of side surfaces 24A, and the edge E11 abuts on the first surface 24B. That is, the first engagement part abuts on the second engagement part at a plurality of different positions. Thus, movement of the connection lead 22 relative to the clip plate 21 is restricted. Accordingly, the displacement of the clip plate 21 with respect to the connection lead 22 can be further suppressed.

In the battery 1 of the present embodiment, it is preferable that the clip plate 21 include a pair of plate parts facing each other, and that the first engagement part be formed on each of the pair of plate parts. The second engagement part of the connection lead 22 is engaged with the first engagement part of the clip plate 21. If the first engagement part is formed in each of the pair of plate parts, it is not necessary to confirm which of the pair of plate parts the first engagement part is formed on when attaching the clip plate 21. Thus, the efficiency of the work of attaching the clip plate 21 to the current collecting tab (the corresponding one of 15B and 16B) is improved. Therefore, the efficiency of manufacturing the battery 1 can be improved.

In the battery 1 of the present embodiment, the joint 25 of the clip plate 21 is preferably formed apart from the first engagement part. The clip plate 21 is, for example, joined with the current collecting tab (the corresponding one of 15B and 16B) by ultrasonic welding. If the joint 25 is formed in the vicinity of the first engagement part, there is a possibility that the second engagement part engaged with the first engagement part may interfere with the joining of the clip plate 21 and the connection lead 22. Therefore, the joint 25 is formed apart from the first engagement part so that the clip plate 21 and the connection lead 22 can be appropriately joined.

### Modification

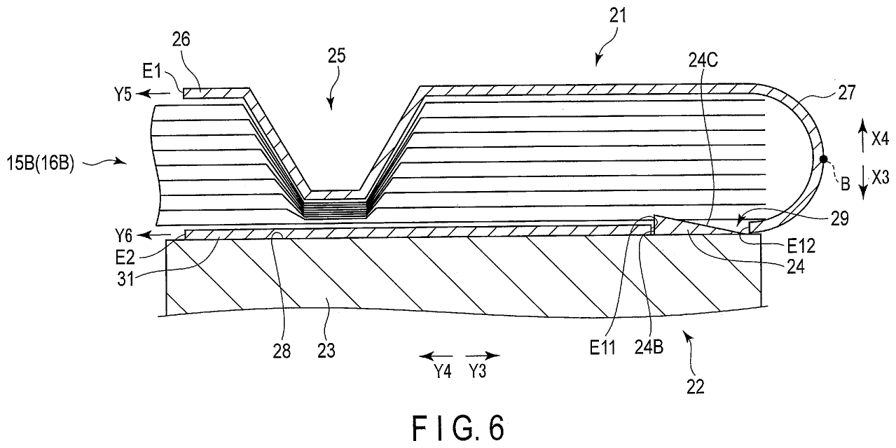

In a modification shown in FIG. 6, the opening part 29 is not formed on the plate part 26, and the opening part 29 is formed only on the plate part 31. In this case, an area where the joint 25 can be formed in the plate part 26 becomes wider. Thus, in a case where the clip plate 21 is joined with the current collecting tab (the corresponding one of 15B and 16B), the clip plate 21 can be easily joined with the current collecting tab.

In at least one of the embodiments, a battery includes an electrode group including a positive electrode, negative electrode, and a current collecting tab, a clip plate, and a connection lead. The clip plate includes a first engagement part, and is attached to the current collecting tab. The connection lead includes a second engagement part engageable with the first engagement part of the clip plate, and is connected to the current collecting tab via the clip plate. Movement of the connection lead relative to the clip plate is restricted by engagement of the second engagement part with the first engagement part. In addition, in a manufacturing method of the battery, an electrode group including a positive electrode, a negative electrode, and a current collecting tab is formed. The clip plate on which the first engagement part is formed is attached to the current collecting tab. The clip plate, current collecting tab, and connection lead are joined in a state in which the second engagement part of the connection lead is engaged with the first engagement part. Thereby, displacement of the clip plate with respect to the current collecting tab is suppressed, and the connection lead is appropriately connected to the current collecting tab.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery comprising:
an electrode including a positive electrode, a negative electrode, and a current collecting tab;
a clip plate including a first engagement part and attached to the current collecting tab; and
a connection lead including a second engagement part engageable with the first engagement part of the clip plate, the connection lead being connected to the current collecting tab via the clip plate, wherein movement of the connection lead relative to the clip plate is restricted by engagement of the second engagement part with the first engagement part.

2. The battery according to claim 1, wherein
the first engagement part is an opening part formed on the clip plate, and
the second engagement part is a protrusion that protrudes from the connection lead.

3. The battery according to claim 2, wherein a protrusion amount of the protrusion from the connection lead decreases toward an end side of the current collecting tab.

4. The battery according to claim 1, wherein
the clip plate includes a pair of plate parts facing each other, and is attached to the current collecting tab in a state of sandwiching the current collecting tab between the pair of plate parts,
the first engagement part is a pair of first engagement parts respectively provided on the pair of plate parts, and
the second engagement part is engaged with one of the pair of first engagement parts.

5. The battery according to claim 1, wherein
the clip plate includes a joint that joins with the current collecting tab, and
the first engagement part is located apart from the joint.

6. A manufacturing method of a battery, comprising:
forming an electrode group including a positive electrode, a negative electrode, and a current collecting tab;
attaching a clip plate on which a first engagement part is formed to the current collecting tab; and
joining the clip plate, the current collecting tab, and the connection lead in a state in which a second engagement part of a connection lead is engaged with the first engagement part.
